(19) United States
(12) Patent Application Publication
(10) Pub. No.: US 2023/0011090 A1
(43) Pub. Date: Jan. 12, 2023

(54) Heater Devices, Methods, and Systems

(71) Applicant: NxStage Medical, Inc., Lawrence, MA (US)

(72) Inventor: Eric ZOGLIO, Derry, NH (US)

(73) Assignee: NxStage Medical, Inc., Lawrence, MA (US)

(21) Appl. No.: 17/779,724

(22) PCT Filed: Nov. 20, 2020
(86) PCT No.: PCT/US2020/061558

§ 371 Date: May 25, 2022

Related U.S. Application Data
(60) Provisional application No. 62/940,394, filed on Nov. 26, 2019.

(51) Int. Cl. F24H 1/12; H05B 3/00

(52) U.S. Cl. CPC F24H 1/121; H05B 3/0052

(57) ABSTRACT

A heating device is designed to heat a liquid while minimizing current that is induced in the liquid. The heating device includes a radiant heat source and a heated member such that the radiant heat source applies radiant energy to the heated member and the heated member is positioned within a vessel. The radiant energy from the radiant heat source is radiated across an empty or gas-filled gap between the radiant heat source and the heated member and the heated member transfers heat to the liquid.

### CROSS-REFERENCE TO RELATED APPLICATIONS

This application claims priority to and the benefit of U.S. Provisional Patent Application No. 62/940,934 filed Nov. 26, 2019, which is hereby incorporated by reference in its entirety.

### BACKGROUND

Immersion heaters heat water by passing the water through an inline vessel containing an immersion heater. The high thermal mass of an immersion heater makes it difficult to control temperature because the thermal mass tends to create an overshoot.

International patent publication WO1995005566A1 describes a variation of an immersion heater which is claimed to heat the water directly by allowing a radiant energy to radiate out of a transparent quartz cylinder. The applicant claims that the radiant energy heats water directly with radiant energy.

### SUMMARY

An inline fluid heater has a lamp that generates radiant energy to a heated member that is opaque and thermally conductive. The heated member surrounds the lamp in such a way that there is an air gap between the heated member and the lamp. A container surrounds the heated member thereby defining a space between the heated member and the container. When the heated member and container are cylindrical in shape, the space is annular. In embodiments, water flows through the annular space. The heated member transfers heat to the water adjacent the heated member by conduction the heated water transfers through the space between the heated member and the container by convection. The lamp does not make contact with the water or most of the heated member. So there is always an air gap between the lamp and the heated member. Thus, the lamp is positioned remotely from the heated member and is surrounded by air so that its radiant energy heats the heated member which in turn heats the water. The result is a rapid-response heater that mitigates one of the primary problems in heating a large mass which is tuning temperature controls precisely without overshoot. Also, by heating the tube with radiant energy from the lamp, the problem of heating water without leakage current for medical applications is mitigated.

A function of the fluid heater is to heat fluid flowing through it efficiently, while rapidly adjusting to various inlet temperature changes due to fluctuations in flow rates, power, inlet temperature, or any other cause of fluctuations that that interfere stable outlet temperatures. The heated member should be of low thermal mass and high conductivity. The lamp should have a rapid response to voltage input. A halogen lamp is an example of rapid response radiant emitter. So is a radiant heater if the characteristics of rapid response to input are provided.

The radiant heat source is separated from the fluid by an air gap and a thermally conductive material. The air gap provides both electrical isolation against patient leakage current and a conduit for heat dissipation. Rapid heat dissipation is a key factor in the heater's performance so the thermally conductive material of the heated member that conducts the heat into the fluid should be thin, have low specific heat, and high conductivity.

The outer container should have a low thermal mass and insulate the fluid from the environment. The fluid connections should be located to provide the longest path (like a swirling flow) or forced convection to facilitate heat transfer from the heated member.

The temperature sensing of the fluid is achieved through a low mass, sensor in the fluid pathway that is in contact with the conductive material that heats the fluid. The sensor can sense and control when there is no fluid present but senses the fluid when the heater is full. This provides a simple yet safe control of the heater.

The responsiveness of a radiant heat source combined with a physical separation of the heat source from the object being heated allows the heater to respond rapidly to changes in temperature. That rapid response means that fluctuation in the heaters power source, flow rates or environmental effects will have a substantially smaller effect on the control of fluid temperature.

The same principles can be applied to a flat surface heater as well as disclosed in the present document.

Other advantages of the disclosed subject matter include that a heater as described can be a smaller, cheaper, energy efficient, design with minimal leakage current to which a patient may be exposed. The heater may be software controlled. In embodiments, dual lamps may be used to provide a backup radiant energy source. Voltage selection software/hardware would not be needed because of the responsiveness of the design it can run at any voltage below the lamps rated voltage.

Objects and advantages of embodiments of the disclosed subject matter will become apparent from the following description when considered in conjunction with the accompanying drawings.

### BRIEF DESCRIPTION OF THE DRAWINGS

Embodiments will hereinafter be described in detail below with reference to the accompanying drawings, wherein like reference numerals represent like elements. The accompanying drawings have not necessarily been drawn to scale. Where applicable, some features may not be illustrated to assist in the description of underlying features

FIGS. 1A and 1B show an inline heater according to embodiments of the disclosed subject matter.

FIG. 2 shows a bag heater according to embodiments of the disclosed subject matter.

FIG. 3 shows an inline heater according to embodiments of the disclosed subject matter.

FIG. 4 shows a bag heater according to embodiments of the disclosed subject matter.

FIG. 5 shows a multiple lamp heating device according to embodiments of the disclosed subject matter.

FIG. 6 shows another embodiment of a multiple lamp heating device according to embodiments of the disclosed subject matter.

### DETAILED DESCRIPTION

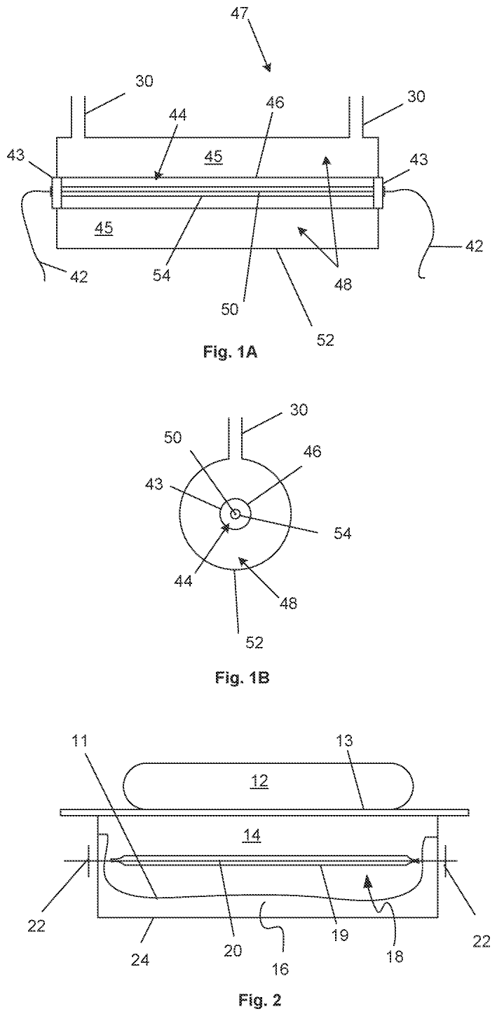

Referring to FIGS. 1A and 1B, an inline heater 47 is shown. The heater 47 has a quartz halogen bulb 54 (also referred to as a quartz tube or simply bulb in this disclosure) as its primary source of heat. The source of radiation is a filament 50 which passes through the quartz tube 54. The radiation emitted by the bulb 54 passes through an air gap 44 and is incident on the inside of the inside surface of the metal tube 46. The metal tube 46 is opaque. Although metal tube 46 is shown, a high thermal conductivity tube may be used that is made of other materials as well. The fluid flowing through an annular space 45 receives heat by convection from the metal tube 46. When the quartz tube lamp is turned off, thereby allowing the filament 50 to cool, the metal tube 46 cools quickly as unheated fluid 48 passes through the annular space 45. The quartz tube 54 is held in the middle of the metal tube 46 by seals 43 at either end of the metal tube 46. Fluid to be heated passes through the ports 30 and into the annular space 45 defined between the metal tube 46 and the canister 52. The heat is conducted through the walls of the metal tube 46 and is transferred by convection to the fluid. The heat also crosses the air gap 44. Electrical leads 42 are provided to run current through the resistive filament.

Referring to FIG. 2, a bag heater employs a quartz tube 19 with a filament 20 inside forming a lamp 18. An insulated bed has a reflective surface 11. The insulation 16 is housed in a housing 24. An air gap 14 is defined in the rectangular space inside the housing 24. The thermal radiation is applied to the under surface of a heating plate 13. A fluid bag 12 rests on the heating plate which absorbs the heat radiation and transfers it to the fluid bag 12. Preferably, for rapid response, the heating plate 13 is thin and made from a material with high thermal diffusivity (high conductivity and low thermal mass) so it has a rapid response to radiant energy incident on the lower surface thereof. Electrical leads 22 are provided to run a current through the lamp 18.

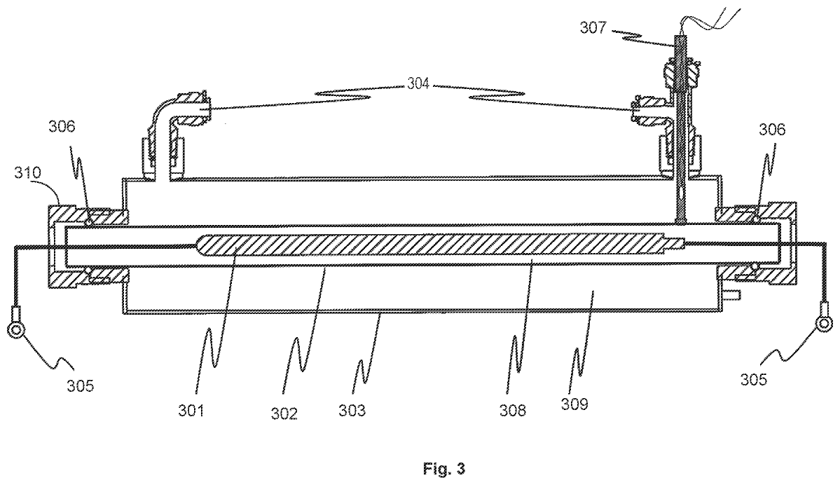

Referring now to FIG. 3, a more detailed version of the inline heater of FIGS. 1A and 1B is shown. A radiant heating element such as a quartz lamp is indicated at 301. A metal tube is indicated at 302. The radiant heating element resides inside the metal tube 302 and there is an air gap 308 defined between the walls of the metal tube 302 and the radiant heating element 301. The radiant energy crosses the air gap 308 to heat the metal tube 302. Ports 304 that admit a flowing liquid to be heated which traverse the annular space 309 between the metal tube 302 and the canister 303. An outlet of one port 304 has a temperature sensor 307. The heater power connections 305 can be seen in FIG. 3. An O-ring 306 provides a seal between the thermally conductive material and the outer container 310. Fluid flows in the annular space between the metal tube 302 and the walls of the canister as indicated at 309.

Note that the air gap in the foregoing embodiments helps to prevent the induction of a leakage current in the fluid flowing through the canister.

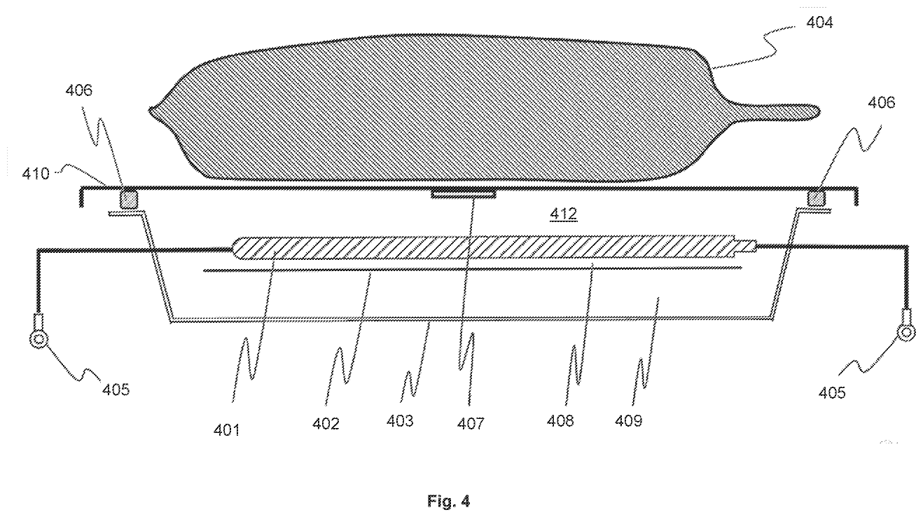

FIG. 4 is a cross section of a bag heater in which a lamp 401 is surrounded by air creating an air gap between a heated plate 410 and the lamp 401. Radiant energy from the lamp 401 is incident on a plate 410. A thermistor 407 is shown adjacent to plate heated plate 410. A reflective plate 402 is located behind the lamp 401. A housing 403 contains the light and isolate the air gap 412 inside the housing 403. A bag rests on the plate 410. When the lamp is active, the radiant energy from the lamp is incident on the plate 410 and the heat is conducted to a bag 404. As in the earlier embodiments, the radiant heat source, the lamp 401 is separated by an air gap 412 from the plate 410 thereby reducing the amount of leakage current induced in the fluid. The lamp is lit by applying current to the leads 405 heater power connections. An insulating separator 406 lies between thermally conductive material and outer container. An air gap 408 which may be filled with insulation is located below the reflector plate 402 inside of space 409.

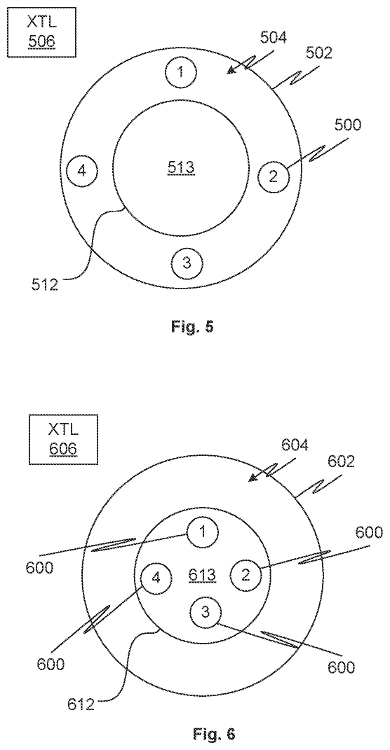

In an alternative embodiment, shown in FIG. 5, fluid flows through an inner space 513 inside of inner tube 512, and one or more radiant heating elements 500 reside in positions surrounding the inner tube 512 and enclosed by outer tube 502. The outer tube 504 may be have a reflecting surface, such as a gold-plated reflector. A space 504 is defined between the outer tube 502 and the inner tube 512, and the radiant heating elements 500 are positioned inside of the space 504. A controller 506 may be configured to control the radiant heat sources 500 so that each radiant heat source 500 takes a turn in sequence thereby extending the life of the radiant heat sources 500 and increasing the maintenance interval which saves expense.

In an alternative embodiment, shown in FIG. 6, fluid flows through an annular space 604 between a tube 612 and one or more radiant and an outside container 602. Radiant heat sources 600 reside in positions within the tube 612. A controller 606 may be configured to control the radiant heat sources 600 so that each radiant heat source 600 takes a turn in sequence thereby extending the life of the radiant heat sources 600 and increasing the maintenance interval which saves expense.

In any of the foregoing embodiments, the air gap may be filled with another gas or it may contain partial or complete vacuum.

According to embodiments, the disclosed subject matter includes a heating device. A radiant heat source applies radiant energy to a heated member. A vessel in contact with the heated member receives the radiant energy from the radiant heat source. The radiant energy being conveyed across an empty or gas-filled gap between the radiant heat source and the heated member.

In variations thereof, the embodiments include ones in which the vessel is a conduit. In variation thereof, the embodiments include ones in which the vessel is filled with water or a medicament.

In variations thereof, the embodiments include ones in which there is a gap between the heated member and the radiant heat source is filled with a gas, a partial or complete vacuum. In variation thereof, the embodiments include ones in which the radiant heat source is a lamp.

In variations thereof, the embodiments include ones in which the lamp is a halogen lamp.

In variations thereof, the embodiments include ones in which the vessel is a plastic bag and the heated member is a thermally conductive plate.

In variations thereof, the embodiments include ones in which the vessel is a cylindrical canister and the heated is a tube mounted within the cylindrical canister such that the vessel is defined as an annular space between the cylindrical canister and tube mounted therewithin.

In variations thereof, the embodiments include ones in which the vessel is a tubular member which resides within a canister and one or more radiant heat sources are located in an annular space between them.

According to embodiments, the disclosed subject matter includes a heating method that includes irradiating a first surface in contact with a fluid by passing radiant energy through a gap filled with a gas or a full or partial vacuum. The method includes conducting heat from said first surface to a second surface opposite said first surface. The method further includes convecting heat from said second surface to a fluid.

In variations thereof, the embodiments include ones that include regulating a temperature of said fluid by regulating a power delivery to said fluid.

In variations thereof, the embodiments in which the radiant heat source includes multiple radiant emitters that are controlled to by a controller to emit radiation in turn as each fails, whereby an interval for replacement of the radiant heat source is expanded.

One general aspect of the disclosure includes a heating device. The heating device also includes a radiant heat source and a heated member, the radiant heat source applying radiant energy to the heated member. The device also includes the heated member being positioned within a vessel. The device also includes the radiant energy from the radiant heat source being radiated across an empty or gas-filled gap between the radiant heat source and the heated member.

Implementations may include one or more of the following features. The device where the vessel is a conduit with inlet and outlet connectors. The radiant heat source includes multiple radiant emitters that are controlled to by a controller to emit radiation in turn as each fails, where an interval for replacement of the radiant heat source is expanded. The vessel is configured to convey flowing fluid. There is a gap between the heated member and the radiant heat source is filled with a gas, a partial or complete vacuum. The radiant heat source is, or includes, a lamp. The lamp is a halogen lamp. The vessel and the heated member are cylindrical and concentric. The vessel is cylindrical and the heated member is cylindrical and mounted concentrically within the vessel such that the vessel surrounds an annular space between vessel and the heated member. The radiant heat source is cylindrical and located concentrically within the heated member. Implementations of the described techniques may include hardware, a method or process, or computer software on a computer-accessible medium.

Another general aspect includes a heating method. The heating method also includes irradiating a member surface in contact with a fluid by passing radiant energy through a gap filled with a gas or a full or partial vacuum. The method also includes conducting heat from said first surface to a second surface opposite said first surface. The method also includes convecting heat from said second surface to a fluid.

Implementations may include one or more of the following features. The method may include regulating a temperature of said fluid by regulating a power delivery to said fluid.

Another general aspect includes a heating device. The heating device also includes a heated member positioned near a radiant heat source with a gap between the heated member and the radiant heat source. The device also includes the radiant heat source being partly surrounded by a chamber leaving an open aperture. The device also includes the heated member at least partly closing the open aperture.

Implementations may include one or more of the following features. The device where the radiant heat source includes a lamp. The lamp is a halogen lamp. The chamber is insulated. The heated member is of metal. The heated member is flat. The chamber contains a reflector within it to reflected radiation from the heat source.

Another general aspect includes a method of heating a fluid. The method of heating also includes providing a radiant heat source in a first enclosed space. The heating also includes providing a fluid housing that receives thermal energy from the radiant heat source. The heating also includes flowing the fluid through the fluid housing at a first flow rate. The heating also includes measuring a temperature of the fluid at a first location in the fluid housing. The heating also includes measuring the temperature at a second location in the fluid housing, downstream from the first location. The heating also includes calculating heat transfer from the radiant heat source to the fluid based on the measuring of the first temperature and the second temperature. The heating also includes controlling at least one of the first flow rate or a driving signal of the radiant heat source in response to the calculating.

It will be appreciated that the control modules and control processes described above can be implemented in hardware, hardware programmed by software, software instruction stored on a non-transitory computer readable medium or a combination of the above. For example, a method for controlling a heater can be implemented, for example, using a processor configured to execute a sequence of programmed instructions stored on a non-transitory computer readable medium. For example, the processor can include, but not be limited to, a personal computer or workstation or other such computing system that includes a processor, microprocessor, microcontroller device, or is comprised of control logic including integrated circuits such as, for example, an Application Specific Integrated Circuit (ASIC). The instructions can be compiled from source code instructions provided in accordance with a programming language such as Java, C++, C#.net or the like. The instructions can also comprise code and data objects provided in accordance with, for example, the Visual Basic™ language, LabVIEW, or another structured or object-oriented programming language. The sequence of programmed instructions and data associated therewith can be stored in a non-transitory computer-readable medium such as a computer memory or storage device which may be any suitable memory apparatus, such as, but not limited to read-only memory (ROM), programmable read-only memory (PROM), electrically erasable programmable read-only memory (EEPROM), random-access memory (RAM), flash memory, disk drive and the like.

Furthermore, the modules, processes, systems, and sections can be implemented as a single processor or as a distributed processor. Further, it should be appreciated that the steps mentioned above may be performed on a single or distributed processor (single and/or multi-core). Also, the processes, modules, and sub-modules described in the various figures of and for embodiments above may be distributed across multiple computers or systems or may be co-located in a single processor or system. Exemplary structural embodiment alternatives suitable for implementing the modules, sections, systems, means, or processes described herein are provided below.

The modules, processors or systems described above can be implemented as a programmed general purpose computer, an electronic device programmed with microcode, a hard-wired analog logic circuit, software stored on a computer-readable medium or signal, an optical computing device, a networked system of electronic and/or optical devices, a special purpose computing device, an integrated circuit device, a semiconductor chip, and a software module or object stored on a computer-readable medium or signal, for example.

Embodiments of the method and system (or their sub-components or modules), may be implemented on a general-purpose computer, a special-purpose computer, a programmed microprocessor or microcontroller and peripheral integrated circuit element, an ASIC or other integrated circuit, a digital signal processor, a hardwired electronic or logic circuit such as a discrete element circuit, a programmed logic circuit such as a programmable logic device (PLD), programmable logic array (PLA), field-programmable gate array (FPGA), programmable array logic (PAL) device, or the like. In general, any process capable of implementing the functions or steps described herein can be used to implement embodiments of the method, system, or a computer program product (software program stored on a non-transitory computer readable medium).

Furthermore, embodiments of the disclosed method, system, and computer program product may be readily implemented, fully or partially, in software using, for example, object or object-oriented software development environments that provide portable source code that can be used on a variety of computer platforms. Alternatively, embodiments of the disclosed method, system, and computer program product can be implemented partially or fully in hardware using, for example, standard logic circuits or a very-large-scale integration (VLSI) design. Other hardware or software can be used to implement embodiments depending on the speed and/or efficiency requirements of the systems, the particular function, and/or particular software or hardware system, microprocessor, or microcomputer being utilized. Embodiments of the method, system, and computer program product can be implemented in hardware and/or software using any known or later developed systems or structures, devices and/or software by those of ordinary skill in the applicable art from the function description provided herein and with a general basic knowledge of controls and/or computer programming arts.

Moreover, embodiments of the disclosed method, system, and computer program product can be implemented in software executed on a programmed general purpose computer, a special purpose computer, a microprocessor, or the like.

It is, thus, apparent that there is provided, in accordance with the present disclosure, heater devices, methods, and systems. Many alternatives, modifications, and variations are enabled by the present disclosure. Features of the disclosed embodiments can be combined, rearranged, omitted, etc., within the scope of the invention to produce additional embodiments. Furthermore, certain features may sometimes be used to advantage without a corresponding use of other features. Accordingly, Applicants intend to embrace all such alternatives, modifications, equivalents, and variations that are within the spirit and scope of the present disclosure.

1. A heating device, comprising:
a radiant heat source and a heated member, the radiant heat source applying radiant energy to the heated member;
the heated member being positioned within a vessel;
the radiant energy from the radiant heat source being radiated across an empty or gas-filled gap between the radiant heat source and the heated member.

2. The device of claim 1, wherein the vessel is a conduit with inlet and outlet connectors.

3. The device of claim 1, wherein the vessel is configured to convey flowing fluid.

4. The device of claim 1, wherein there is a gap between the heated member and the radiant heat source is filled with a gas, a partial or complete vacuum.

5. The device of claim 1, wherein the radiant heat source is, or includes, a lamp.

6. The device of claim 5, wherein the lamp is a halogen lamp.

7. The device of claim 5, wherein the vessel and the heated member are cylindrical and concentric.

8. The device of claim 1, wherein the vessel is cylindrical and the heated member is cylindrical and mounted concentrically within the vessel such that the vessel surrounds an annular space between the vessel and the heated member.

9. The device of claim 8, wherein the radiant heat source is cylindrical and located concentrically within the heated member.

10-11. (canceled)

12. A heating device, comprising:
a heated member positioned near a radiant heat source with a gap between the heated member and the radiant heat source;
the radiant heat source being partly surrounded by a chamber leaving an open aperture; and
the heated member at least partly closing the open aperture.

13. The device of claim 12, wherein the radiant heat source includes a lamp.

14. The device of claim 13, wherein the lamp is a halogen lamp.

15. The device of claim 12, wherein the chamber is insulated.

16. The device of claim 12, wherein the heated member is of metal.

17. The device of claim 12, wherein the heated member is flat.

18. The device of claim 12, wherein the chamber contains a reflector within it to reflected radiation from the heat source.

19. The device of claim 1, wherein the radiant heat source includes multiple radiant emitters that are controlled to by a controller to emit radiation in turn as each fails, whereby an interval for replacement of the radiant heat source is expanded.

20. A method of heating a fluid, the method comprising:
providing a radiant heat source in a first enclosed space;
providing a fluid housing that receives thermal energy from the radiant heat source;
flowing the fluid through the fluid housing at a first flow rate;
measuring a temperature of the fluid at a first location in the fluid housing;
measuring the temperature at a second location in the fluid housing, downstream from the first location;
calculating heat transfer from the radiant heat source to the fluid based on the measuring of a first temperature and a second temperature; and
controlling at least one of the first flow rate or a driving signal of the radiant heat source in response to the calculating.

21. The method of claim 20, further comprising regulating the temperature of said fluid by regulating a power delivery to said fluid.
